(19) United States
(12) Patent Application Publication
(10) Pub. No.: US 2010/0281955 A1
(43) Pub. Date: Nov. 11, 2010

(54) MICROTUBE AND RELATED METHODS THEREFOR

(75) Inventors: Edmund Y. Ting, Kent, WA (US); Alexander Lazarev, Lexington, MA (US); Richard Schumacher, Taunton, MA (US); Charles Dussault, Taunton, MA (US); Wayne Fritzche, So. Easton, MA (US)

Correspondence Address: LANDO & ANASTASI, LLP, ONE MAIN STREET, SUITE 1100, CAMBRIDGE, MA, 02142, US

(73) Assignee: PRESSURE BIOSCIENCES INC., South Easton, MA (US)

(21) Appl. No.: 12/774,577

(22) Filed: May 5, 2010

Related U.S. Application Data
(60) Provisional application No. 61/175,771, filed on May 5, 2009.
(60) Provisional application No. 61/175,507, filed on May 5, 2009.

(51) Int. Cl. G01M 3/00

(52) U.S. Cl. 73/49.8

(57) ABSTRACT

Sample processing devices having collapsible, flexible bodies are disclosed. The flexible microtube sampling devices are utilizable in pressure mediated, pressure cycling procedures. Externally applied pressure on the flexible microtube sample processing devices allow buckling thereof and transfer of the applied pressure to the sample contained therein.

### CROSS-REFERENCE TO RELATED APPLICATION

This application claims the benefit of priority to U.S. Provisional Patent Application No. 61/175,507, titled MICROTUBE, filed on May 5, 2009, and to U.S. Provisional Patent Application No. 61/175,771, titled MICROTUBE AND RELATED METHODS THEREFOR, filed on May 5, 2009, each of which is entirely incorporated herein by reference for all purposes.

### BACKGROUND OF THE INVENTION

1. Field of the Invention

The present disclosure relates to systems and methods for preparing, isolating, and purifying specimens, and in particular, components, systems, and techniques related to pressure cycling. This disclosure is in the general field of techniques and devices for preparing and processing biological samples, optionally in connection with analysis and/or detection of materials from a sample. Particular embodiments have applications in biotechnology, medical diagnostics, agriculture, food, forensic, pharmaceutical, environmental, and veterinary science.

2. Description of Related Art

Biological samples can be subjected to analysis after they are processed and isolated. Processing of such samples typically involves one or more of the following: homogenization of biological tissues, lysis of cells, suspension, or dissolution of solid particulates, and liquefaction of solid material. Sample preparation can also entail extensive enzymatic digestion, the use of harsh chemical reagents, with or without mechanical disruption techniques. The sample can be further processed or isolated by using a variety of techniques such as polymerase chain reaction (PCR) or gel electrophoresis to purify or amplify particular molecules of interest such as nucleic acids and/or proteins in a sample. After further processing, samples can be subjected to one or more of any of detection and analytical procedures.

Particular difficulties can be encountered in the application of molecular analytical techniques to, for example, plant and certain animal tissues and bacteria with rigid cell walls such as, but not limited to, mycobacterium. Methods for extracting biological molecules from such samples are typically limited by the requirement for complex processing using multiple steps and can thus be time-consuming, labor intensive, and costly. Processing of such bacteria or tissue, for example, can require extensive pretreatment with enzymes such as lysozyme or proteinase IL, or grinding with glass beads. For some cells and tissues, additional mechanical disruption may also be utilized in equipment or devices such as mortar and pestles, bead mills, rotor-stator homogenizers, Polytron® homogenizers, blade blenders, ultrasonicators, pulverizers, pestle and tube grinders, meat mincers, or a French Press. Extensive processing steps may be required, for example, for the preparation and extraction of insoluble (inclusion-body) proteins, such as those produced by high-level expression of recombinant bacterial constructs.

Analysis of the biological properties of samples can require further procedures, such as detection of nucleic acids, proteins, antibodies, factors, or activities extracted from the sample. Such further procedures can require additional steps such as hybridization of nucleic acids with specific primers or probes, amplification, and detection of specific signals. In the analysis of protein or antibody activity, binding to, or elution from specific ligands, antigen-antibody reactivity, or another processing approach can further involve identification and/or purification of the desired products. Examination of biological activity can also include incubation of an extract with a cascade of enzymes and/or co-factors to generate a detectable product.

### SUMMARY

One or more aspects of the disclosure are directed to a sample processing device for use in a pressure modulation apparatus, comprising a unitary flexible cylindrical cartridge or body having a sealed end and an open end; and a rigid cap having a sealing section having a outer diameter sized to provide interference fit against an inner surface of the open end of the flexible cylindrical cartridge. The flexible cylindrical cartridge or body can comprise a hydrophobic material. The flexible cylindrical cartridge can comprise a hydrophobic polymeric material. The flexible cylindrical cartridge or body can have a surface coated with a fluorinated polymeric material. The flexible cylindrical cartridge or body can comprise a surface having a contact angle with water of at least 90° at 25° C. The device can further comprise a linkage coupling the cap to the flexible cylindrical cartridge or body. The cap can have a sample retrieving cavity defined within the sealing section.

One or more aspects of the disclosure are directed to a sample processing assembly comprising a plurality of cylindrical sample cartridges having a sealed end and an open end, and a drum having a plurality of chambers annularly disposed therein, each of the chambers sized to receive one of the plurality of cylindrical sample cartridges. The assembly can further comprise an annular retaining member having an outer diameter in a range of between about 50% and 100% of an outer diameter of the drum. The assembly can further comprise a securing pin configured to secure the annular retaining member to an end of the drum. The assembly can further comprise a connecting pin couplable to the drum at least one end thereof.

One or more aspects of the invention pertain to a method of processing a biological sample, comprising introducing the biological sample into an unitary flexible body having a crease in a wall thereof; sealing the unitary flexible body with a cap to produce a sealed microtube; pressurizing the external surface of the sealed microtube at an applied pressure of at least 20,000 psig to collapse the flexible body in a preferred buckling mode and thereby transferring the applied pressure to the biological sample; and reducing the applied pressure to relieve the microtube from the preferred buckling mode. In some cases, the method can further comprise repeating the steps of pressurizing and reducing the applied pressure. In still further cases, the method can comprise assembling a plurality of sealed microtubes, each of which has a sample contained therein, and disposing each of the plurality of sealed microtubes in a drum.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A is a schematic illustration of a sample processing device, herein also referred to as “MicroTube,” having a cartridge section and a cap in accordance with one or more aspects of the invention;

FIG. 1B is a schematic illustration of a cap of the sample processing device in accordance with one or more aspects of the invention;

FIG. 2 is a representation of a sample processing device, showing a cartridge section and a plurality of caps in accordance with one or more embodiments of the invention;

FIG. 3 is a copy of a photograph of sample processing devices in accordance with one or more embodiments of the invention, and particularly showing embodiments including a cartridge with a hemispherical end and a cartridge with a flattened end that facilitates a preferred buckling mode;

FIG. 4A is a schematic illustration of a plurality of sample processing devices disposed in a drum or holder assembly in accordance with one or more aspects of the invention;

FIG. 4B is a schematic illustration of a plurality of drums each having a plurality of sample processing devices, in accordance with one or more embodiments of the invention;

FIG. 5A is a copy of a photograph showing a plurality of sample processing devices disposed in a drum in accordance with one or more aspects of the invention;

FIG. 5B is a copy of a photograph showing a plurality of sample processing devices disposed in a drum and a retaining member securing each of the sample processing devices in the drum, in accordance with one or more aspects of the invention;

FIG. 6 is a copy of a photograph showing a plurality of sample processing devices to be disposed in drums along with retaining members for securing each of the sample processing devices in the drums, in accordance with one or more aspects of the invention;

FIG. 7 is a copy of a photograph showing a plurality of sample processing devices disposed in a drum secured with a retaining member and coupled with a linking member, in accordance with one or more aspects of the invention;

FIG. 8 is a copy of photograph showing a plurality of sample processing devices disposed in a drum in accordance with one or more aspects of the invention;

FIG. 9 is a schematic illustration of a plurality of sample processing devices disposed in a drum in accordance with one or more aspects of the invention;

FIG. 10 is a copy of a photograph showing a pressure cycling system that is configured to receive at least one sample processing device, as well as a retrieving tool, configured to couple to a drum having the at least one sample processing device, in accordance with one or more aspects of the invention;

FIG. 11 is a schematic illustration of a tool that can be utilized to facilitate handling of a cap of the sample processing device, in accordance with one or more aspects of the invention;

FIG. 12 is a copy of a photograph showing a tool that can be utilized to facilitate handling or removal of a cap of the sample processing device, in accordance with one or more aspects of the invention;

FIG. 13 is a schematic illustration of a sample processing device with a member connecting the cartridge to the cap, in accordance with one or more aspects of the invention;

FIG. 14 is a schematic illustration of a plurality of sample processing devices cyclically linked together, each of the sample processing devices having a cap connected thereto, in accordance with one or more aspects of the invention;

FIG. 15 is a schematic illustration of the cyclically linked plurality of sample processing devices illustrated in FIG. 14 and further showing breaking at least one link thereof to reconfigure the plurality of devices into a serially linked chain that can be advantageously disposed in a sample well, in accordance with one or more aspects of the invention;

FIGS. 16A-16C are copies of photographs of sample processing devices utilized in bead beating processing techniques, in accordance with one or more aspects of the invention;

FIG. 17 is a graph showing the recovered amount of protein from various samples after bead beating processing in sample processing devices, in accordance with one or more aspects of the invention;

FIG. 18 is schematic illustration showing sample disruption, extraction, and fractionation by pressure cycling with ProteoSolve-SB, with panel 1 depicting a starting condition at atmospheric pressure of two immiscible solvents “a” and “b,” with panels 2 and 3 depicting disruption of the solid sample upon the application thereto of high pressure and partial mixing of the solvents, with panels 4 and 5 depicting the fractionation of components in the immiscible solvents upon release or reduction of the applied high pressure, that can be utilized in accordance with one or more aspects of the invention;

FIGS. 19A-19C are graphs showing the protein yields from pressure mediated processing with conventional devices (left) and from pressure mediated processing with the sample processing devices (right) from liver, brain, and adipose tissue samples, in accordance with one or more aspects of the invention;

FIGS. 20A-20C are copies of photographs of liver, brain, and adipose samples following sodium dodecyl sulfate polyacrylamide gel electrophoresis (SDS-PAGE) processing from conventional (control) and utilizing the sample processing devices (Microtube), in accordance with one or more aspects of the invention; and

FIG. 21 is a copy of a photograph of RNA extracted from rat liver tissue following pressure mediated processing and electrophoretic assay utilizing the sample processing devices, in accordance with one or more aspects of the invention.

### DETAILED DESCRIPTION

The present invention provides gentle, yet effective procedures and systems that facilitate release of desirable, target molecules. The present invention can further be directed to advantageous techniques and systems that prepare, process, and analyze biological samples using equipment, and procedures and systems that simplify the overall process while, in some cases, providing standardized methods over a wide range of specimen types, to be amenable to automation, and while limiting extent or degree of degradation of sample components, particularly biomolecules.

The techniques and systems of the present invention thus provide for the advantageous simplification or automation, or both, of sample preparation steps that save time and expenses, and yet can produce reliable and consistent information from analytical techniques, because of, for example, reduced manual handling of the sample.

One or more aspects of the various devices, systems, and techniques disclosed herein provide for or facilitate various purification and/or analytical steps that are amenable to automation including, for example, where at least one of the processes is achieved or involves using high pressure to facilitate sample preparation or isolation.

One or more aspects of the various devices, systems, and techniques disclosed herein can be based, at least in part, on the application of cycled pressure, variable temperatures, or both, to one or more samples in a device having, for example, multiple chambers that are separated by penetrable and/or porous barriers that can allow biological samples to be processed in a controlled and automated manner. While the device or system can be amenable to use with liquid samples, it can also be used in a similar manner with solid and semi-solid samples, such as whole plant or animal tissue.

One or more aspects of the various devices, systems, and techniques disclosed herein can reduce the need to transfer samples and reagents during processing procedures. For example, in accordance with one or more embodiments of the invention, large portions of specimens can be fragmented into smaller pieces and then homogenized to completion, while avoiding unacceptable degradation of targeted biomolecules, before further processing by, for example, digestion or amplification. The various devices, systems, and techniques of the present invention advantageously facilitate the efficient release of one or more target or desirable biomolecules such as, but not limited to, nucleic acids or proteins, while preserving the characteristics of such molecules, e.g., in the lysate form.

After the sample has been homogenized, lysed or otherwise further prepared, and at least a portion of the biomolecules have been released, at least a portion of the sample or portions of components thereof, can be further processed. Further processing can include, but is not limited to, one or a combination of the following processes: purification by, for example, any one or more of chromatography, solid phase capture, and gel electrophoresis; enzymatic processing; amplification of biomolecules, for example, by PCR; detection of protein interactions; chemical modification; labeling; solubilization of substrate or portions thereof; and substrate detection.

In accordance with still further aspects of the invention, various techniques can be used in conjunction with pressurized processing procedures, such as by high hydrostatic pressure cycling technology (“PCT”). The use of such pressurized processing techniques to facilitate analysis of biological samples is described in, for example, the following references, each of which is incorporated herein by reference in their entirety for all purposes: U.S. Pat. No. 6,111,096 to Laugharn, Jr. et al.; U.S. Pat. No. 6,120,985 to Laugharn, Jr. et al.; U.S. Pat. No. 6,127,534 to Hess, R. and Laugharn, Jr.; U.S. Pat. No. 6,245,506 to Hess, R. and Laugharn, Jr.; U.S. Pat. No. 6,258,534 to Laugharn, Jr. et al.; U.S. Pat. No. 6,270,723 to Laugharn, Jr. et al.; U.S. Pat. No. 6,274,726 to Laugharn, Jr. et al.; and PCT Application No. WO/1999/022868 to Laugharn, Jr. et al. Physical changes effected on the sample can include pressure-driven phase changes, volume changes under high pressures and homogenization, for example, as solids or other matter pass through screens. Such processes can be adaptable to automation.

The sample preparation device and assemblies disclosed herein, such as the collapsible wall microtube can be used in a pressure modulation apparatus such as a BAROCYCLER® device, from Pressure BioSciences Inc., South Easton, Mass.

The tubes can be made of plastic, rubber, ceramic, metal, or glass or any combination of these materials. For example, the chamber can contain a volume up to about 10μL, 50μL, 100μL, up to about 500μL, up to about 1 mL, or up to about 100 mL. The surface of one or more chambers can be rendered inert to the sample which can be comprised of biomolecules. In some cases, the tubes are comprised of non-wetting flexible materials or have a contact angle of at least 90° relative to water. In some cases, at least a portion of the inner surface of the tubes can have a non-wetting and/or inert coating. The flexible material preferably has an elastic modulus at 25° C. of about 50,000 psi to about 200,000 psi. Further, the flexible material can provide the body with a capability of resisting internal rupture pressure of up to 300 psi.

A portion of the surface of one or more chambers can also be derivatized with biomolecules or small organic molecules such as pharmaceutically active compositions or metal chelators, through covalent bonding, ionic interactions, or non-specific adsorption. In other cases, a portion of the inner surface of the tube can comprise a biologically active coating, which can be disposed under a water-soluble coating, which can be dissolved or otherwise removed during use.

The tube can be made of polyvinyl chloride, polyether sulfone, nylon, nitrocellulose, cellulose esters, cellulose acetate, cellulose nitrate, polyfluoroethylene, vinyl, polypropylene, polycarbonate, or other material.

The tube can, for example, include a wall, and a cap having one or more annular seals, e.g., O-ring seals that contact the inner surface of the tube. The seal can be, for example, made of a polymeric material.

Multiple tubes can, optionally, be interconnected and utilized within the pressure-modulation apparatus. In some cases, a plurality of devices, e.g., 2, 3, 4, 6, 8, 10, 12, or more, can be interconnected to form a ring, or can be interconnected to form a two-dimensional matrix, e.g., a 2×2, 3×5, 4×4, 4×6, or 8×12 array).

In some cases, one or more chambers containing a reagent can annularly surround a sample chamber containing the sample, in which case the reagent can be introduced to the sample within the tube.

The biological sample can be exposed to elevated pressures, e.g., at least 100 psi, 250 psi, 500 psi, 750 psi, 1,000 psi, 5,000 psi, 10,000 psi, 20,000 psi, 30,000 psi, 40,000 psi, 50,000 psi, 60,000 psi, 70,000 psi, 80,000 psi, 90,000 psi, 100,000 psi, or more.

The sample can include, for example, a solid material, a semi-solid material, and/or a liquid. In particular embodiments, the sample can be a biological material such as, but not limited to, an insect, a fungus, plant or animal tissue, a food product or agricultural product, a forensic sample, a human tissue, such as muscle, tumor, or organ, serum, sputum, blood, or urine, or portions thereof. The biological sample can be frozen. The size of the biological sample can be, for example, between about 0.1 mg and 500 g, e.g., 0.1 mg to 1.0 mg, 1.0 mg to 10 mg, 10 mg to 100 mg, 100 mg to 1 g, 1 g to 20 g, 20 g to 100 g, 100 g to 200 g, 200 g to 500 g.

The elevated pressure can be applied to the sample at, above, or below ambient temperature. In some cases, the pressure can be applied while the sample is at a temperature below which the sample would freeze at atmospheric pressure, i.e., the sample's atmospheric pressure freezing temperature, at a temperature in the range of that temperature to about 4° C., between about 4° C. and ambient temperature, at a temperature in the range between ambient and 90° C. or higher e.g., −80° C., −40° C., −20° C., 0° C., 4° C., 10° C., 15° C., 20° C., 25° C., 30° C., 37° C., 40° C., 50° C., 60° C., 70° C., 80° C., 90° C., 100° C., or higher.

The elevated pressure can also be repeatedly cycled, e.g., a frequency in the range of milliseconds, e.g., 1 to 10000 Hz, at a frequency in the range of seconds, e.g., 0.01 to 1 Hz, or at a frequency in the range of minutes, e.g., 0.1 to 10 MHz.

The method can also include the steps of analyzing the sample after, or as part of, sample preparation, extracting a specific substance or substances from the biological sample, and/or processing a specific substance or substances from the biological sample. For example, DNA, RNA, proteins, or pharmaceutical compositions, e.g., pharmaceutically active molecules, natural products, drugs, or drug metabolites, in the sample can be isolated after or as part of the sample preparation; and/or a portion of the sample, e.g., a nucleic acid, can be amplified by, for example, using polymerase chain reaction, “PCR”, or ligase chain reaction, “LCR” techniques, bound to a ligand, eluted from a ligand, sequenced, or hybridized; and/or a portion of the sample can be subjected to chemical reactions including but not limited to antigen-antibody interactions, enzymatic reactions, catalytic reactions, or step-wise reactions wherein a different step takes place in the tube.

Processing such as homogenization can be achieved by applying cyclic pressure, resulting in perturbations of large, multi-molecular structures (such as cell membranes) leading to their destruction. The homogenization process can also be applied to material that has already been fragmented by the methods described above or by other methods, or to frozen material, which can become a slurry by introduction of repeated phase changes such as liquid/solid phase changes, further contributing to cell breakage. The low temperatures can help preserve biological activity during the process.

The pressure cycling process described can contribute to cell disruption by a variety of mechanisms. Successful practice of the invention does not depend on any particular theory of its operation.

Processing can be effected by pressure cycling at relatively high temperatures, such as 50° C. to 90° C. or at moderate temperatures such as −5° C., 0° C., 4° C., 10° C., 20° C., 25° C., 30° C., 37° C., or 45° C. The mechanism of high temperature homogenization can be different from that at low temperature, as the solubility of biomolecules, such as lipids and polysaccharides, can be increased at the high temperature. There is a potential problem in that the degradation of biomolecules can increase at the higher temperatures and can be further exacerbated by increased activity of proteases or nucleases at the high temperatures. Nevertheless, a high pressure process at high temperature can be suitable and even preferable for certain stable proteins, nucleic acids, and other molecules at appropriate temperatures and pressures. For example, RNAses can be inactivated to generate high yield and high quality RNA without the use of harsh chemicals. The present techniques can be performed at subzero temperatures so that the integrity of biological molecules, such as RNA and enzymes, are preserved from degradation and remain functional.

Pressure cycling techniques utilized in the present disclosure can involve hydrostatic pressure or mechanical pressure applied uniformly to the sample in a closed container. The device can accommodate an intact tissue sample.

Additionally, the present devices and techniques can be suitable in the study of protein content and activities within cells and tissues. Some notable features of the present method that contribute to protein stability include low shear, rapid lysis, and high protein concentrations.

The apparatus and techniques disclosed herein facilitate release of cellular contents while maintaining the integrity and biological activity of the liberated molecules with or without detergents, harsh chemicals, or excessive shearing forces. Thus, where advantageous, the devices and techniques can be used with detergents and other chemicals, which are compatible with maintenance of biological activity or where maintenance of biological activity is not necessary or not desired. Additional stabilizing additives such as, but not limited to, proteinase inhibitors, glycerol, DTT, or specific cofactors can be utilized, with or without a buffer, to further ensure the integrity of the target biomolecules so that, for example, the biological activities of enzymes, such as monomeric proteins, remain fully functional.

Portions of exposed or “wetted” surfaces of the tubes disclosed herein can be derivatized in a manner appropriate for the sample and the desired processing. For example, at least a portion of the surface can be coated with a material causing the surface to be inert to biomolecules, preventing attachment or adsorption thereof. In another embodiment, at least a portion of the surface can be covalently bonded or ionically attached to one or more biomolecules or pharmaceutical products, e.g., small compounds capable of interacting with or trapping elements of the sample.

Materials or samples that can be processed in the present devices and techniques include, but are not limited to, blood, serum, forensic samples, fungi, insects, plant tissue (e.g., pollen, leaves, roots, flowers or other plant parts, whether fresh, frozen, or dried), and animal tissue, e.g., avian, reptilian, fish, or mammalian tissue such as human, bovine, canine, feline, murine, or porcine tissue. Tissues can include biopsy specimens, crops, or foods.

Advantages of the present invention over the conventional methods include the following; frozen samples can be processed without thawing; one step fragmentation, homogenization, and processing can be carried out with minimum hands-on operation; lysis protocols can be tailored for specific biological samples, having the materials necessary for analysis and suitable for follow-up assays pre-loaded into the device; sample size can be flexible ranging from milligrams to hundreds of grams and the sample can be in whole pieces; the process can be applied to a broad spectrum of sample types, such as liquid, solid, or semi-solid tissues; lysing and further processing and or analysis can be performed in automated pressure cycling equipment; if desired, homogenization can be performed rapidly, without the need for lengthy incubation such as those that involve enzymatic digestion steps.

The process can include an automated molecular extraction procedure, such as, automated nucleic acid extraction method such as those disclosed in U.S. Pat. No. 6,111,096, which is incorporated herein by reference for all purposes, or similar extraction methods.

Samples can be processed in a closed disposable holder, preventing cross contamination of specimens. Specimens can be collected in the field, placed and stored in the device until processing, minimizing specimen handling.

The process can be adapted for simultaneous or sequential processing. The device can be adapted to process multiple samples, for example, by being set-up in a matrix such as a 96-well format. The process can be adapted for many applications, such as, forensic, clinical, pathological, agricultural, food safety, pharmaceutical, bio-terrorism, and environmental analysis. Organisms can be grown, processed, analyzed, and/or rendered inert within the device, e.g., a device containing a growth or transport medium. Of special importance when working with potentially dangerous or fastidious organisms, these methods can be carried out either with or without the need to open the device between sample collection/loading and rendering inert, thus minimizing possible hazards associated with handling of such organisms.

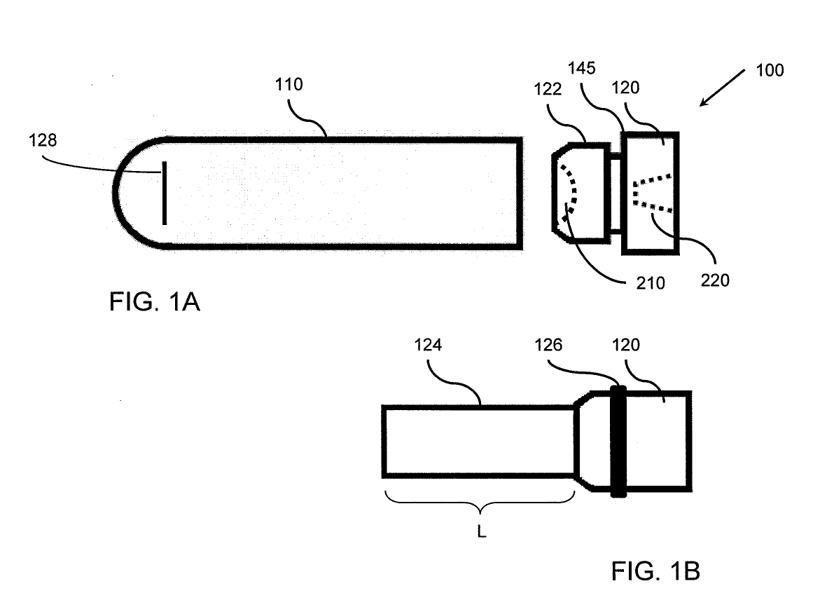

FIG. 1A shows a sample processing device or microtube in accordance with one or more aspects of the invention. The microtube 100 can have a collapsible body 110 and a cap 120. Cap 120 can have a sealing section 122 that is sized to have an outer diameter that is more than the inner diameter of the body 110 so that an interference fit is created therebetween. In some cases, cap 120 can have a shoulder or flange that prevents cap 120 from being fully disposed or contained within body 110.

FIG. 1B illustrates an alternative embodiment of cap 120 with at least one seal 126, typically at least two seals. Exemplary embodiments of seal 126 can involve O-rings disposed circumferentially disposed around a portion of cap 120 which interfaces with the internal surface of body 110 and create a fluid seal therebetween. Thus, in the variant of FIG. 1B, the sealing section is not necessarily sized to provide an interference fit against the inner surface of body 110. The microtube can be designed to transfer maximum pressure to a sample that is placed in the collapsible body 110. Cap 120 is typically comprised of a rigid material that does not buckle or collapse under an externally applied pressure when device 100 is externally pressurized. Body 110, in contrast, is typically comprised of a flexible material that deforms under the externally applied pressure. When an external pressure, e.g., hydrostatic external pressure, is applied, collapse or buckling of the flexible body will transfer the applied pressure to the contained sample. In some instances of such cases, volume contraction thereof may be at least 15% if no compressible fluid is contained within microtube 100. In instances where a compressible fluid, e.g., air or other gas, is contained in microtube 100, contraction of the contained volume can be over 90%.

The collapsible body is typically comprised of a resilient, non-rigid material that can buckle under an applied external pressure thereby transferring the applied pressure to the sample contained within the body. Preferably, the collapsible body is comprised of an inert material. In other cases, the body is comprised of a non-wetting or hydrophobic polymeric material. In still other cases, the inner surface of the microtube is coated with an inert, hydrophobic or non-wetting material. For example, the microtube and/or the cap can be comprised of a fluorinated polymeric material, such as, but not limited to, fluorinated ethylene propylene (FEP), silicone, polyethylene, PTFE, or blends thereof.

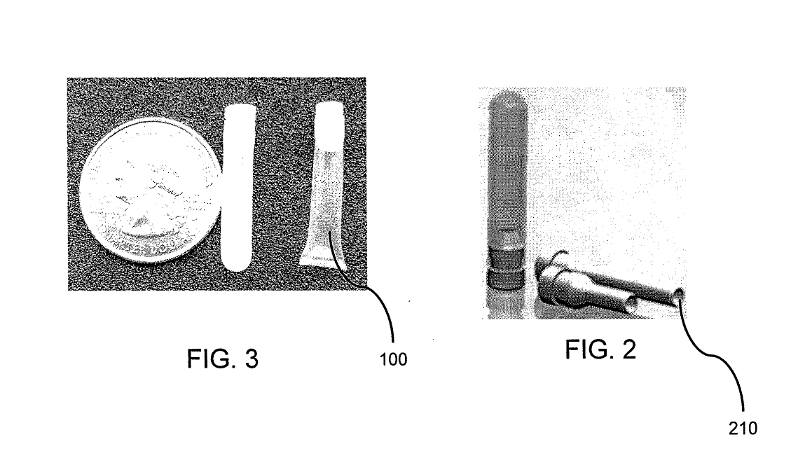

The volume enclosed within the microtube is defined by the dimensions of the body and the cap. The volume of the microtube can be, for example, 1μL, 2 μL, 5μL, 10μL, 15μL, 25,μL, 50μL, 75μL, 100μL, 150μL, 500μL, 1,000μL, or 2,000μL. However, the internal volume can be defined by utilizing caps having differing displacing volumes such as those illustrated in FIG. 1B and FIG. 2. Thus as shown, cap 120 can have a protrusion section 124, with a length L, extending from the sealing section, into the volume of the collapsible body thereby reducing the effective enclosing volume thereof. The cross-sectional area and the length L of section 124 define an displacement volume within body 110.

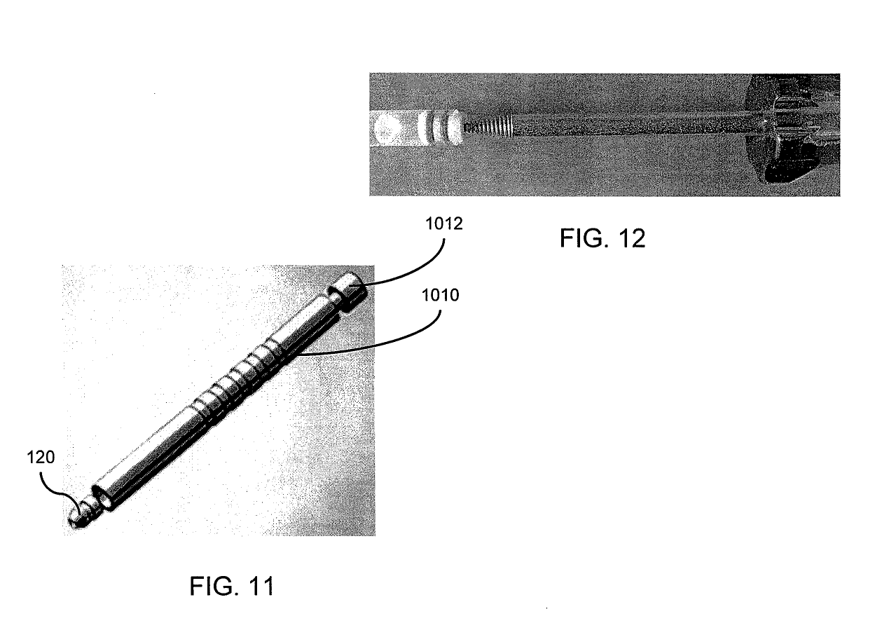

As exemplarily illustrated in FIGS. 1A and 2, the cap 120 of microtube 100 can have a sample holding cavity 210 that can be utilized to capture or contain an amount of a sample for insertion into the body. The sample holding cavity can be used to retrieve a sample from, for example, a 2D gel to facilitate transfer thereof. A tool 1010, as exemplarily shown in FIG. 11, can be used to hold cap 120 during sample capture and insertion into cavity 210 of cap 120. A releasing button 1012 can be incorporated into tool 1010 that, when depressed, can release cap 120 from tool 1010. The sample cavity can have a predetermined volume such as 0.1μL, 0.2μL, 0.5μL, 1μL, 1.5μL, 2μL, 5μL, 10μL, 15μL, 20μL, 25μL, 50μL, or 100 pt.

Cap 120 is preferably re-closable and can optionally have features such as grooves or ridges that interface with an automated cap removal tool. Optionally, the cap can utilize helical threads (not shown) to facilitate coupling to the body. Cap 120 can be made of metal, e.g., titanium, stainless steel, or aluminum, a polymeric material, such as a plastic, e.g., thermoplastic such as polypropylene, p-phenylene sulfide, or glass reinforced PEI resin, a glass, stone, or a ceramic material.

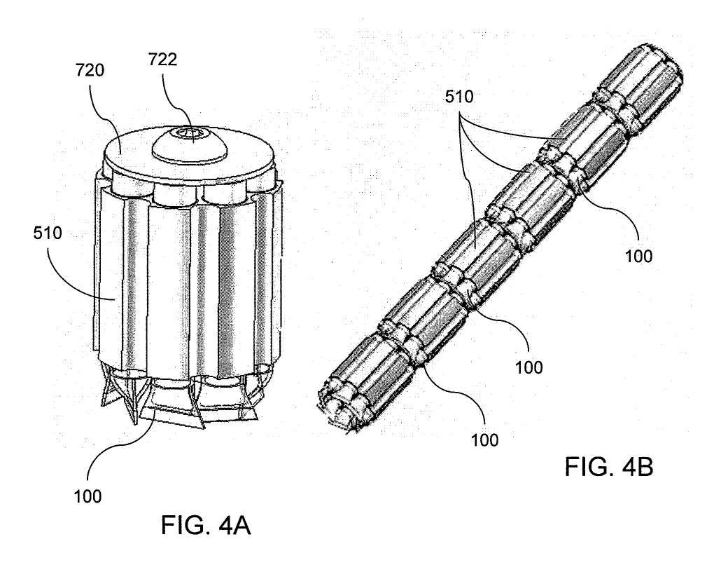

In service, the collapsible body buckles under an applied external pressure thereby transferring the pressure to the sample contained therein. In some cases, the body can have features that promote a preferred buckling or collapsing mode. For example, and as illustrated in FIG. 4, body 110 can have a flattened section that preferentially induces a 2-dimensional compression when pressure is externally applied. In other cases, one or more longitudinal creases 128 across or along body 110 can promote the preferred buckling mode. Crease 128 can be a channel in the wall of body 110. Other configurations of crease 128 can involve ridges or pleats that provide controlled deformation of the body along a preferred orientation or buckling mode.

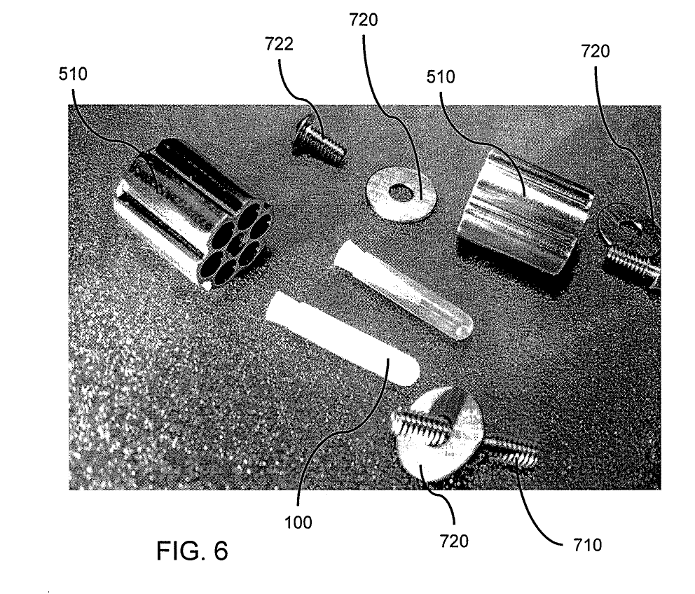

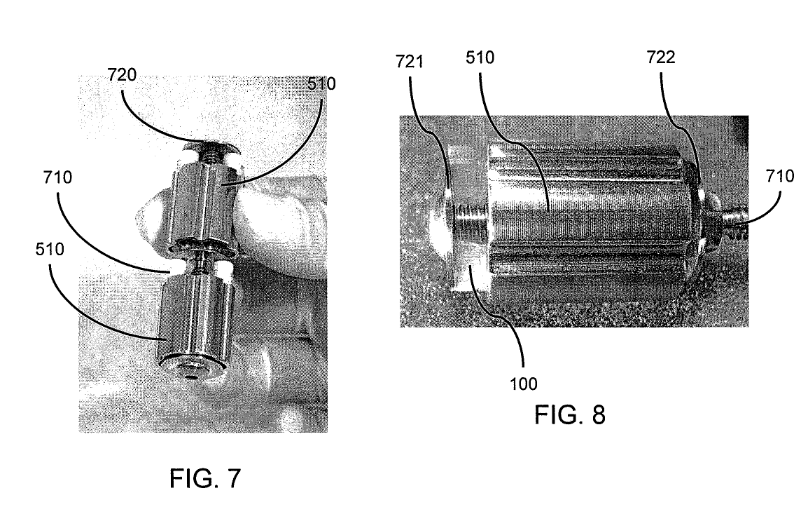

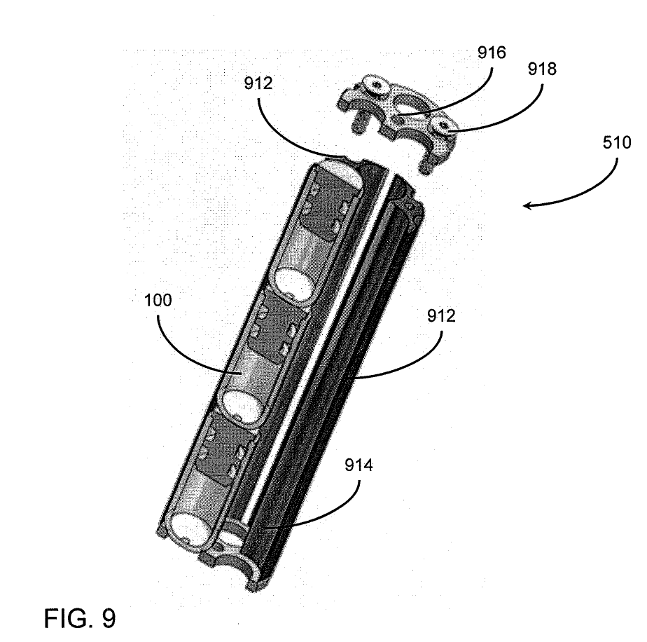

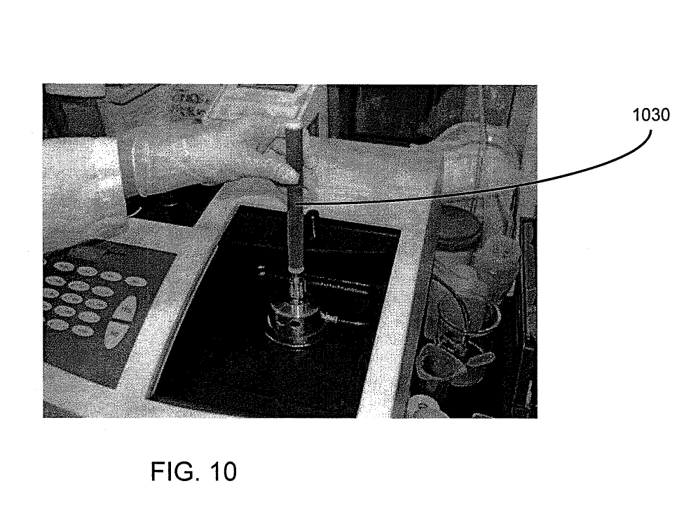

FIGS. 4A-9 schematically illustrate further advantageous features and configurations of the invention. A cylinder or drum 510 can be utilized to carry or secure one or more microtubes 100 therein during the application of external pressure thereon, pressure cycling operations, or pressure mediated procedures. As exemplarily illustrated, drum 510 can have a plurality of annularly disposed chambers 522. Preferably, each chamber 522 secures one microtube. A plurality of drums can be coupled serially, as exemplarily illustrated in FIGS. 4B and 7. The plurality of coupled drums containing a plurality of sample microtubes can be inserted into a pressurizing chamber for pressure mediated processes. One or ore connectors or linking members 710, such as a threaded element illustrated in FIG. 7, can be utilized to couple the drums together. Chamber 522 can be sized to confine body 120 or tube 100 and prevent undesirable expansion thereof.

In preferred configurations, an optional annular retaining member 720 can also be utilized to securely retain the one or more microtubes 102 in respective chambers 522 of drum 510. One or more retaining bolts 722 can be utilized to secure retaining member 720 to the body of drum 510 and prevent cap 120 from being undesirably removed from body 110. Thus, for example, member 720 and chamber 522 can be sized to apply a compressive force on cap 120 of microtube 100. In such configurations, each chamber 522 of drum 510 can have a closed end upon which an end of microtube 100 abuts and a closed end through which microtube 100 is inserted. Member 720 can then be utilized to apply the compressive pressure on microtube 100 by having a displacement or dimension, between the closed end and member 720, that is less than a length of the microtube. In other configurations, chamber 522 can have open ends. In such variants, at least two retaining members 720 can be utilized to secure microtube 100. As illustrated for example in FIG. 8, a first member 721 can be disposed against a closed end of microtube 100 and a second member 722 can be disposed against and to secure cap 120.

In accordance with one or more variants, drum 510 can comprise connectable one or more linkages 912, each having at least a partial channel 914 therein and sized to fit one or more microtubes therein when linkages 912 are connectably assembled to form drum 510. One or more securing flanges 916 may be utilized with one or more retaining members, such as bolts 918, fasten each of linkages 912 together.

In some configurations, a handling tool can be coupled or connected to the one or more drums holding one or more microtubes to facilitate insertion thereof into a processing device. For example, handling tool 1030 can be coupled, by threading, for example, to drum 510 and assist insertion thereof into a pressure chamber of a pressure cycling device, such as a BAROCYCLER® device, from Pressure BioSciences Inc., for pressure mediated processes to be performed on one or more microtubes. In still other configurations, cap 120 can have a handle or loop on the surface facilitate its insertion or removal of the cap into the body or into a pressure cycling apparatus. In some particularly advantageous configurations, cap 120 comprises a connecting section 220 that is capable of coupling or being attached to a retrieval tool as shown in FIG. 12. As illustrated, the retrieval tool can have a threaded end that attaches to section 220 of cap 120 to facilitate removal and/or handling of cap 120 or even microtube 100.

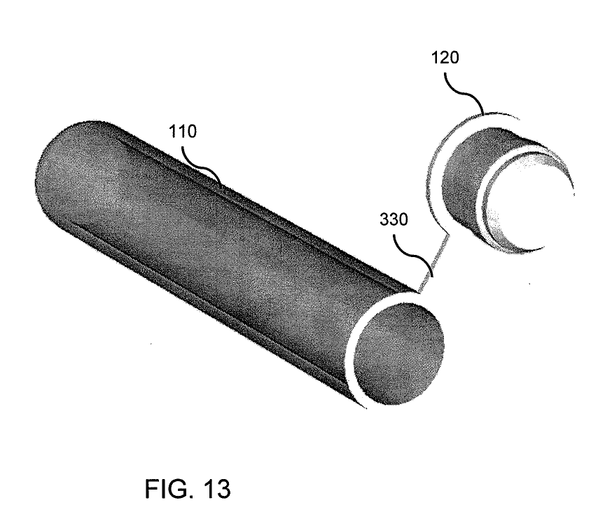

Cap 120 can also be coupled or connected to body 110 as illustrated in FIG. 13 by one or more flexible connectors 330.

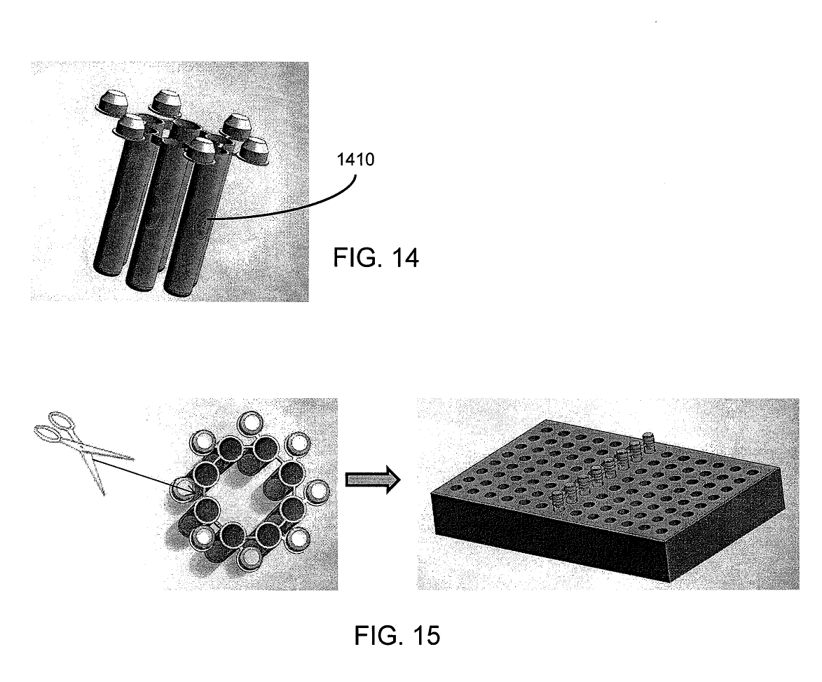

Exemplarily illustrated in FIGS. 14 and 15 is an assembly of microtubes cyclically linked as a ring. Each of the linked microtubes of the linked assembly can be respectively inserted into a chamber of the drum. As illustrated in FIG. 11, each of the microtubes can have one or more indicia 1410 on an external surface thereof for sample identification. Indicia 1410 can be a writable surface.

After pressurization or pressure cycling operations, one or more linkages of the linked assembly can be severed as illustrated in FIG. 15 to unravel the ring form into a serially connected chain, or into individual microtubes, which can be conveniently disposed into wells of a microtiter plate.

Reagents that can be utilized in the various techniques herein can include those required for amplification of nucleic acid sequences, for example, those used in polymerase chain reaction (PCR), ligase chain reaction (LCR), or reverse-transcriptase polymerase chain reaction (RT-PCR). Pressure cycling in the chamber containing these reagents can also be used to enhance these reactions. Temperature cycling can also be incorporated with these reaction conditions.

Retrieval of the microtubes from the pressurization apparatus, such as BAROCYCLER® from Pressure BioSciences Inc., can be facilitated by utilizing a wand. Preferred configurations can involve wand with a magnetic end that magnetically couples metallic drum assembly.

The presently disclosed devices and techniques thus provide a flexible sample container with a removable cap that allows externally applied pressure to transfer into a sample. A hydrostatic fluid can provide the external pressure, which can be up to 500 psi, 1,000 psi, 2,000 psi, 5,000 psi, 10,000 psi, 20,000 psi, 25,000 psi, or 30,000 psi. As noted, the cap can be sized to provide an interference fit that is further secured into the body by the externally applied hydrostatic pressure. In some cases, the cap is secured without threads. Other advantageous features can involve the use of mechanical compression to constrain the cap prior to, during, and after pressurization operations to ensure against sample leakage.

Further features involve the use of low surface tension, non-wetting materials to facilitate retrieval samples with minimal or reduced losses associated with portions of the sample being retained on the surfaces.

The body and caps of the microtubes can be fabricated by, for example, injection molding.

In still other configurations, microtube 100 can comprise a cylindrical body 110 open at both ends. In such cases, microtube 100 can utilize two caps 120 to close each open thereof.

### Example 1

This example illustrates the use of the sample processing devices (MicroTubes) of the present invention in bead beating techniques to recover protein from various samples.

Samples of kidney and lung tissues (20 mg) with phosphate buffered saline (PBS) or IEF buffer (100 μL) along with about ten to fifteen 1 mm diameter zirconia beads were introduced into each sample processing device.

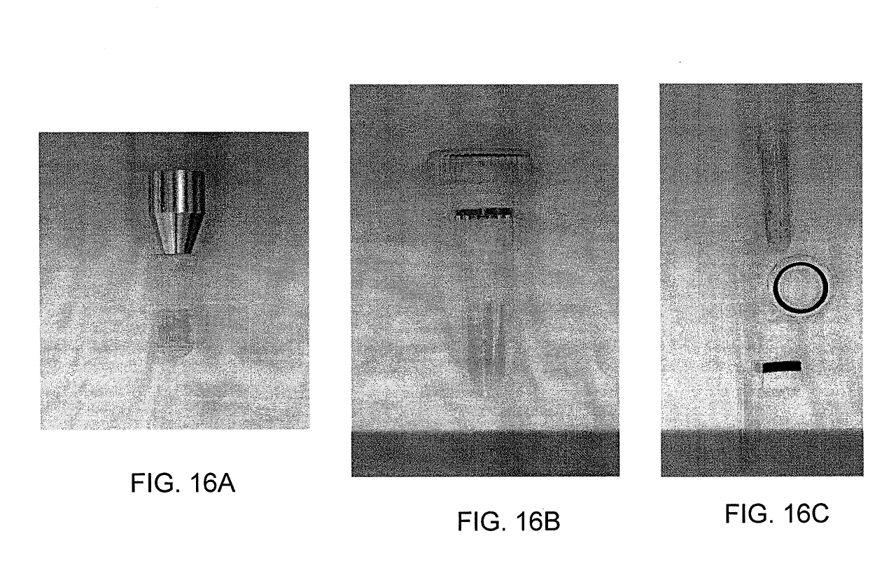

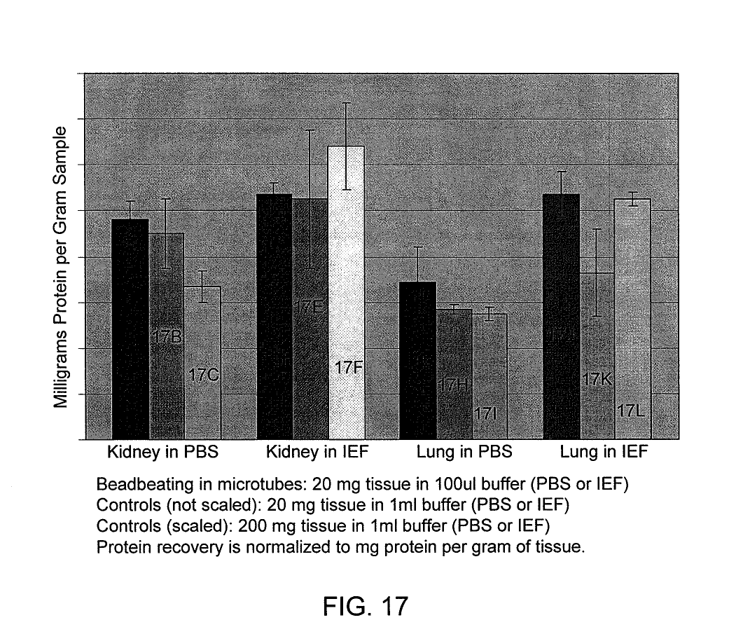

FIGS. 16A-16C show a representative sample before and after bead beating. FIG. 17 shows the protein recovery, mg protein per gram sample, for the various tissue samples after bead beating in the sample processing devices of the invention (17A, 17D, 17G, and 17J) as well as the protein recovery rate for non-normalized samples processed conventionally with 1 mL buffer (17B, 17E, 17H, and 17K) and normalized samples also processed conventionally with 1 mL buffer (17C, 17F, 171, and 17L).

### Example 2

This example illustrates total protein extraction from small tissue samples using PCT MicroTubes with a ProteoSolve-SB™ reagent kit.

Extraction of total proteins from tissue can be limited by the poor solubility of some proteins in traditional extraction buffers. Such limitation can also be applicable for lipid-rich samples such as adipose tissue. Traditional detergent-based sample preparation methods may not adequately dissociate all proteins, especially hydrophobic proteins which may be tightly associated with membrane lipids. Isolation of such proteins can be inefficient and a substantial fraction of membrane proteins is typically discarded in the insoluble pellet after tissue extraction. Therefore, proteomic analysis of tissues can be biased toward the more soluble proteins.

Sample processing devices (MicroTubes) of the present invention were utilized with ProteoSolve-SB protocol, scaled down to use with tissue samples in the 10-20 mg size range to be compatible with biopsy-size tissue samples.

PCT Sample Preparation System (PCT SPS)

The Pressure Cycling Technology Sample Preparation System (PCT SPS) uses rapid cycles of hydrostatic pressure between ambient and ultra high pressure levels to control biomolecular interactions. The PCT SPS can be used to disrupt tissues, cells, and cellular structures to extract proteins and nucleic acids as well as lipids and small molecules. High hydrostatic pressure acts preferentially on the more compressible constituents of the sample, such as lipids and proteins; this selective energy distribution results in destabilization of molecular interactions but not in the disruption of covalent bonds. In addition, the PCT SPS can be used to accelerate enzymatic reactions such as trypsin and proteinase K digestion.

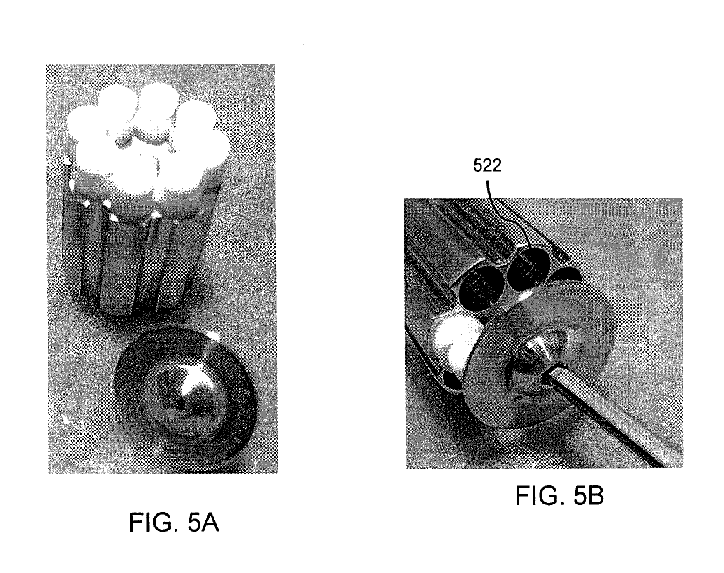

PCT SPS involved a microprocessor-controlled bench-top instrument (BAROCYCLER® NEP3229 or the NEP2320 from Pressure BioSciences Inc.) in combination with single-use sample processing containers. For large-scale samples, about 1.4 ml per sample, PCT SPS is used with conventional FT500 PULSE tubes. For small-scale samples, about 50 to about 150 μL per sample, higher throughput applications, PCT MicroTubes of the present invention, as schematically depicted in FIG. 5A, were utilized. The MicroTubes utilized had volumes of 150μL each and were arranged in a drum and pressure cycled in a BAROCYCLER® NEP 3229.

ProteoSolve-SB and PCT

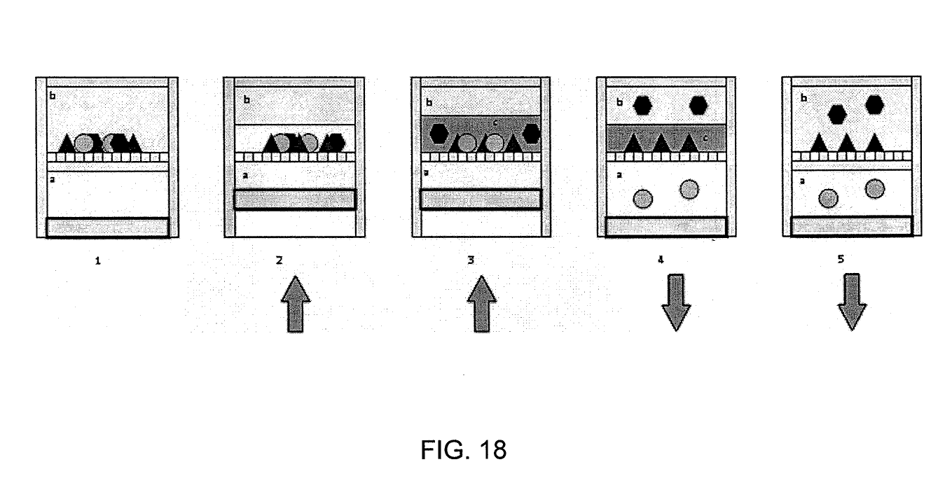

The ProteoSolve-SB kit utilized a detergent-free extraction reagent combined with sample disruption by PCT to extract proteins from a variety of tissues, including lipid rich samples such as adipose tissue as well as protease-rich tissues such as pancreas. This method takes advantage of a synergistic combination of sample disruption by alternating hydrostatic pressure and a unique reagent system that partitions extracted proteins and lipids into separate fractions as schematically illustrated in FIG. 18, with sample disruption, extraction, and fractionation by PCT in the ProteoSolve-SB kit. In FIG. 18, panel 1 shows a starting condition at atmospheric pressure with two immiscible solvents “a” and “b.” Panels 2 and 3 of FIG. 18 show the application of pressure: when high pressure is applied (up arrows), the solid sample is disrupted and the two solvents partially mix to form a transient solvent “c.” Panels 4 and 5 of FIG. 18 show the effect of pressure release (down arrows), the sample components fractionate, and solvents “a” and “b” separate.

For small-scale extraction by PCT with the ProteoSolve-SB kit, about 10 mg of rat liver, about 20 mg of rat adipose, and about 20 mg of mouse brain were placed into a PCT MicroTube of the invention. About 100 μL of ProteoSolve-SB Reagent A and about 35 μL of Reagent B were added in the about 150 μL MicroTubes, each of which were capped.

Control samples were scaled up 10-fold to keep the mass-to-volume ratio constant in all samples. About 100 mg of rat liver, about 200 mg of rat adipose, and about 200 mg of mouse brain were placed into a conventional FT-500 PULSE Tube. About 1.0 mL of ProteoSolve-SB Reagent A and about 350 to about 400 μL of Reagent B were added to bring the total volume to about 1.4 mL per PULSE tube. All samples were thoroughly vortexed for about 10 to about 20 seconds before and after PCT. Pressure cycling was performed in a BAROCYCLER® NEP3229 or NEP2320 for 20 cycles at ambient temperature. Each cycle consisted of 20 seconds at 35,000 psi followed by 10 seconds at atmospheric pressure. After pressure cycling, the large-scale samples were transferred from the PULSE Tubes into 2 mL microcentrifuge tubes. The small-scale samples were centrifuged directly in the MicroTubes, placed into standard 1.7 mL microcentrifuge tubes for proper support in the centrifuge rotor. All samples were centrifuged for about 15 minutes at 12,000 g to separate the upper lipid phase from the protein-containing lower phase. The solubilized protein fractions were transferred to new tubes and two 10 μL aliquots from each sample were dried by evaporation in a fume hood. The first replicate aliquot was used for protein quantification by Bradford assay. The second was dissolved in 1X Laemmli buffer for SDS-PAGE.

Pressure-mediated extraction in combination with the ProteoSolve-SB reagents is shown to be an efficient detergent-free method for protein extraction from lipid-rich adipose tissue as well a variety of other tissues. This example shows that the ProteoSolve-SB kit protocol can be scaled down for use with the new the MicroTubes of the present invention to efficiently extract proteins from small samples.

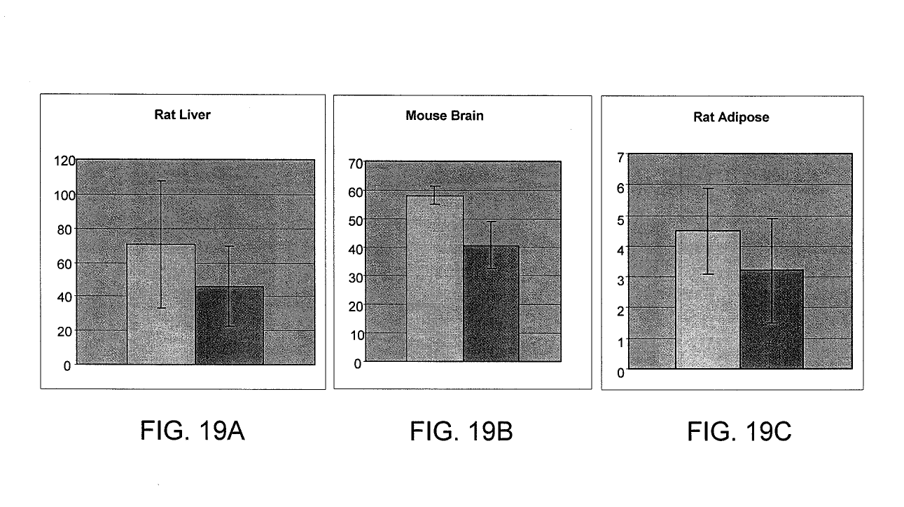

FIGS. 19A-19C show the protein yields from the rat liver, mouse brain, and rat adipose samples, respectively, using the conventional PULSE tube (left bar, n=2 per tissue) and the MicroTube (right bar, n=4 per tissue). Protein recovery is expressed as micrograms extracted protein per milligram tissue.

Conventional methods for protein extraction from tissues for proteomic analysis typically rely upon mechanical disruption such as Dounce or other homogenizers, or mortar and pestle grinding. Such conventional methods, however, may not be suitable for use with small samples due to the potential for relatively large amount of loss during sample processing and handling. Further, such conventional methods rely upon detergents such as SDS, Triton X-100 or CHAPS to solubilize membranes and extract proteins which may be incompatible with downstream analysis methods thereby requiring extensive sample conditioning to remove the incompatible agents with further potentially to protein loss. In contrast, utilizing the detergent free techniques, such ProteoSolve-SB, and can be efficiently removed from the extracted sample by evaporation or precipitation.

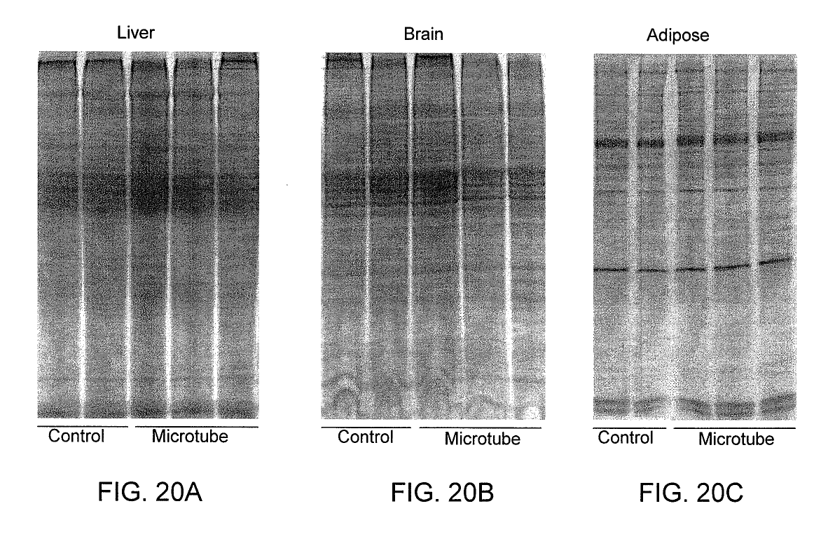

Tissue disruption by pressure cycling in the MicroTubes of the present invention, coupled with protein extraction using the detergent-free ProteoSolve-SB kit, resulted in improved yield of proteins from a variety of small tissue samples. After extraction, aliquots of the protein-containing fractions were run on 8-16% Tris-glycine polyacrylamide gradient gels. Control samples were extracted in 1.4 ml conventional PULSE Tubes, Micro samples were extracted in PCT MicroTubes. The protein recovery, in μg of extracted protein per mg of starting material is illustrated in the results presented in FIGS. 20A to 20C, relative to the electrophoretically processed samples after conventional pressure mediated processing (control).

### Example 3

This example illustrates extraction of RNA from solid tissue using PCT MicroTubes.

RNA was extracted from frozen/thawed rat liver tissue (Pel-Freeze). Tissue pieces, about 12 to 14 mg each, were cut from a single block of liver and placed individually into PCT MicroTubes of the invention. After addition of about 0.14 ml of TRIZOL reagent solution, from Invitrogen, the microtubes were capped with 150-μL sized caps, mixed well by vortexing, and subjected to pressure cycling (PCT) at 35,000 psi for 20 cycles (20 seconds at high pressure and 5 seconds at atmospheric pressure, per cycle). RNA was isolated from the resulting lysate using the standard TRIZOL protocol. Final RNA pellets were dissolved in about 30 μl of diethylpyrocarbonate (DEPC) treated water. RNA recovery was spectrophotometrically evaluated (NANODROP) and quality was assessed by agarose gel electrophoresis.

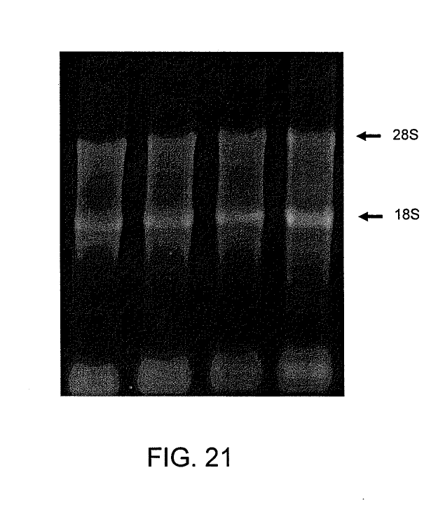

RNA recovery from the 12-14 mg of tissue samples were 13.5 mg of RNA (±0.2 mg, n=4). Gel electrophoresis confirmed intactness of the RNA as shown in FIG. 21.

Having now described some illustrative embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives.

Those skilled in the art should appreciate that the parameters and configurations described herein are exemplary and that actual parameters and/or configurations will depend on the specific application in which the systems and techniques of the invention are used. Those skilled in the art should also recognize or be able to ascertain, using no more than routine experimentation, equivalents to the specific embodiments of the invention. It is therefore to be understood that the embodiments described herein are presented by way of example only and that, within the scope of the appended claims and equivalents thereto; the invention may be practiced otherwise than as specifically described.

Moreover, it should also be appreciated that the invention is directed to each feature, system, subsystem, or technique described herein and any combination of two or more features, systems, subsystems, or techniques described herein and any combination of two or more features, systems, subsystems, and/or methods, if such features, systems, subsystems, and techniques are not mutually inconsistent, is considered to be within the scope of the invention as embodied in the claims. Further, acts, elements, and features discussed only in connection with one embodiment are not intended to be excluded from a similar role in other embodiments.

As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A sample processing device for use in a pressure modulation apparatus, comprising:
an unitary flexible body having a sealed end and an open end; and
a rigid cap having a sealing section with an outer diameter sized to provide interference fit against an inner surface of the open end of the flexible cylindrical cartridge.

2. The device of claim 1, wherein the flexible body comprises a hydrophobic material.

3. The device of claim 2, wherein the flexible body comprises a hydrophobic polymeric material.

4. The device of claim 3, wherein the flexible body has a surface coated with a fluorinated polymeric material.

5. The device of claim 1, wherein the flexible body comprises a surface having a contact angle with water of at least 90° at 25° C.

6. The device of claim 1, further comprising a linkage coupling the cap to the flexible body.

7. The device of claim 1, wherein the cap has a sample retrieving cavity defined within the sealing section.

8. The device of claim 1, wherein the flexible body has a crease that induces a preferred buckling mode.

9. A sample processing assembly comprising:
a plurality of sample cartridges having a sealed end and an open end; and
a drum having a plurality of chambers annularly disposed therein, each of the chambers sized to receive one of the plurality of cylindrical sample cartridges.

10. The assembly of claim 9, further comprising an annular retaining member having an outer diameter in a range of between about 50% and 100% of an outer diameter of the drum.

11. The assembly of claim 10, further comprising a securing pin configured to secure the annular retaining member to an end of the drum.

12. The assembly of claim 11, further comprising a connecting pin couplable to the drum at least one end thereof.

13. A method of processing a biological sample, comprising:
introducing the biological sample into an unitary flexible body having a crease in a wall thereof;
sealing the unitary flexible body with a cap to produce a sealed microtube;
pressurizing the external surface of the sealed microtube at an applied pressure of at least 20,000 psig to collapse the flexible body in a preferred buckling mode and thereby transferring the applied pressure to the biological sample;
reducing the applied pressure to relieve the microtube from the preferred buckling mode.

14. The method of claim 13, further comprising repeating the steps of pressurizing and reducing the applied pressure.

15. The method of claim 14, further comprising assembling a plurality of sealed microtubes, each of which has a sample contained therein, and disposing each of the plurality of sealed microtubes in a drum.
